(19) United States
(12) Patent Application Publication
(10) Pub. No.: US 2012/0164534 A1
(43) Pub. Date: Jun. 28, 2012

(54) GRAPHENE/LiFePO4 CATHODE WITH ENHANCED STABILITY

(76) Inventors: Daiwon Choi, (US); Jun Liu, Richland, WA (US); Zhenguo Yang, Richland, WA (US); Wei Wang, Kennewick, WA (US); Gordon L. Graff, West Richland, WA (US)

(21) Appl. No.: 12/980,328

(22) Filed: Dec. 28, 2010

(51) Int. Cl. H01M 4/583; H01M 4/86; B82Y 30/00

(52) U.S. Cl. 429/221; 252/182.1; 429/231.8; 429/224; 429/223; 977/773; 977/734; 977/742

(57) ABSTRACT

A lithium ion battery having an anode, an electrolyte, and a cathode comprising nano-structured carbon in electrical communication with LiFePO₄. The cathode of the lithium ion battery of the present invention has sufficient structural stability to maintain at least 90-99 percent of the specific capacity of the cathode over 500 charge/discharge cycles.

The invention was made with Government support under Contract DE-AC0676RLO 1830, awarded by the U.S. Department of Energy. The Government has certain rights in the invention.

### BACKGROUND OF THE INVENTION

The need for improved electrical storage devices has led to the extensive study of LiFePO₄ as the cathode material for lithium ion batteries. The low-cost, low toxicity and relatively high theoretical specific capacity of these materials has made them especially interesting to researchers seeking to provide practical energy storage solutions. However, these efforts have not proven successful, as the materials have not shown the long life cycles required in practical commercial applications. Specifically, investigations of LiFePO₄ as the cathode material for lithium ion batteries have failed to produce a cathode material that maintain a high specific capacity over numerous charge/discharge cycles as is required in commercial applications.

For example, in a recent paper entitled “Preparation of nano-structured LiFePO₄/graphene composites by co-precipitation method” Y. Ding, Y. Jiang, F. Xu, J. Yin, H. Ren, Q. Zhuo, Z. Long, P. Zang, Electrochemistry Communications 12 (2010) 10-13 the authors recognize that graphene materials with superior electrical conductivities and high surface area would be advantageous for applications in energy storage. The authors then describe a method for making LiFePO₄/graphene composites by a co-precipitation method. Finally, the authors show the results of the material under the charge/discharge conditions typical of commercial applications. Unfortunately, after as few as 80 charge/discharge cycles, the authors report that the cells retain only about 97% of their initial specific capacity. This level of degradation is unacceptable in applications that require hundreds, if not thousands, of charge/discharge cycles.

Another recent paper entitled “A facile method of preparing mixed conducting LiFePO₄/graphene composites for lithium-ion batteries” Li Wang, Haibo Wang, Zhihong Liu, Chen Xiao, Shanmu Dong, Pengxian Han, Zongyi Zhang, Xiaoying Zhang, Caifeng Bi, Guanglei Cui, Solid State Ionics 181 (2010) 1685-1689 describes the preparation of a LiFePO₄/graphene mixed conducting network through a hydrothermal route followed by heat treatment. This composite showed a 5% drop in the specific capacity after fewer than 60 charge/discharge cycles.

Accordingly, those having ordinary skill in the art recognize a need for LiFePO₄/graphene composites that maintain their specific capacity over large numbers of charge/discharge cycles, particularly when used in lithium-ion batteries. The present invention fills that need.

### SUMMARY OF THE INVENTION

The present invention is thus a cathode comprising nano-structured carbon in electrical communication with LiMPO₄, where M is a transition metal ion. The cathode of the present invention has sufficient structural stability to maintain at least 90 percent of the specific capacity of the cathode over 500 charge/discharge cycles. More preferably, the cathode of the present invention has sufficient structural stability to maintain at least 95 percent of the specific capacity of the cathode over 500 charge/discharge cycles. Even more preferably, the cathode of the present invention has sufficient structural stability to maintain at least 98 percent of the specific capacity of the cathode over 500 charge/discharge cycles. Even more preferably, the cathode of the present invention has sufficient structural stability to maintain at least 99 percent of the specific capacity of the cathode over 500 charge/discharge cycles.

The element M in the LiMPO₄ is selected from the group consisting of Fe, Mn, Co, Ni and combinations thereof. Preferably, while not meant to be limiting, the M in the LiMPO₄ is Fe. The nano-structured carbon comprises graphene, carbon nano-tubes, and combinations thereof. Preferably, while not meant to be limiting, the nano-structured carbon comprises graphene.

The present invention further includes a lithium ion battery having an anode, an electrolyte, and a cathode comprising nano-structured carbon in electrical communication with LiMPO₄, where M is a transition metal ion. The cathode of the lithium ion battery of the present invention has sufficient structural stability to maintain at least 90 percent of the specific capacity of the cathode over 500 charge/discharge cycles. More preferably, the cathode of the lithium ion battery of the present invention has sufficient structural stability to maintain at least 95 percent of the specific capacity of the cathode over 500 charge/discharge cycles. Even more preferably, the cathode of the lithium ion battery of the present invention has sufficient structural stability to maintain at least 98 percent of the specific capacity of the cathode over 500 charge/discharge cycles. Even more preferably, the cathode of the lithium ion battery of the present invention has sufficient structural stability to maintain at least 99 percent of the specific capacity of the cathode over 500 charge/discharge cycles.

The element M in the LiMPO₄ is selected from the group consisting of Fe, Mn, Co, Ni and combinations thereof. Preferably, while not meant to be limiting, the M in the LiMPO₄ is Fe. The nano-structured carbon comprises graphene, carbon nano-tubes, and combinations thereof. Preferably, while not meant to be limiting, the nano-structured carbon comprises graphene.

### BRIEF DESCRIPTION OF THE DRAWINGS

The following detailed description of the embodiments of the invention will be more readily understood when taken in conjunction with the following drawings, wherein:

FIG. 1 is an XRD pattern and FESEM image of nanostructured LiFePO₄ in one embodiment of the present invention.

FIG. 2a is a graph of the electrochemical cycling at various C rates for anatase TiO2/graphene in experiments demonstrating one embodiment of the present invention.

FIG. 2b is a graph of the electrochemical cycling at various C rates for LiFePO4 in experiments demonstrating one embodiment of the present invention.

FIG. 2c is a graph of the electrochemical cycling at various C rates for LiFePO4-anatase TiO2/graphene full cell in experiments demonstrating one embodiment of the present invention.

FIG. 2d is a graph of the voltage profiles of charge/discharge at various C rates for anatase TiO2/graphene in experiments demonstrating one embodiment of the present invention.

FIG. 2e is a graph of the voltage profiles of charge/discharge at various C rates for LiFePO4 in experiments demonstrating one embodiment of the present invention.

FIG. 2f is a graph of the voltage profiles of charge/discharge at various C rates for LiFePO4-anatase TiO2/graphene full cell in experiments demonstrating one embodiment of the present invention.

FIG. 3(a) is a graph showing dq/dv peaks of all electrodes tested at C/5 in experiments demonstrating one embodiment of the present invention.

FIG. 3(b) is a Ragone plot comparison of LiFePO4, anatase TiO2/graphene and LiFePO4-anatase TiO2/graphene full cell in experiments demonstrating one embodiment of the present invention.

FIG. 3(c) is a graph of the cycling performance of the LiFePO₄-anatase TiO₂/graphene full cell at 1 Cₘ rate in experiments demonstrating one embodiment of the present invention.

### DETAILED DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitations of the inventive scope is thereby intended, as the scope of this invention should be evaluated with reference to the claims appended hereto. Alterations and further modifications in the illustrated devices, and such further applications of the principles of the invention as illustrated herein are contemplated as would normally occur to one skilled in the art to which the invention relates.

A series of experiments where conducted to demonstrate one embodiment of the present invention. Briefly, in these experiments, Li-ion batteries made from a LiFePO₄ cathode and an anatase TiO₂/graphene composite anode were investigated for potential applications in stationary energy storage. Fine-structured LiFePO₄ was synthesized by a novel molten surfactant approach described herein, whereas the anatase TiO₂/graphene nanocomposite was prepared via a self-assembly method. The full cell was then operated at 1.6 V, wherein it demonstrated negligible fade in the specific capacity even after more than 700 cycles at measured 1 C rate. The results are the first known in the art to show the cathode maintaining sufficient structural integrity to avoid degradation of the specific capacity.

Fine-structured LiFePO₄ was synthesized using LiCOOCH₃.2H₂O (reagent grade, Sigma), FeC₂O₄.2H₂O (99%, Aldrich), NH₄H₂PO₄ (99.999%, Sigma-Aldrich), oleic acid (FCC, FG, Aldrich) and paraffin wax (ASTM D 87, mp. 53-57° C., Aldrich). NH₄H₂PO₄ was milled with oleic acid for 1 h using high energy mechanical mill (HEMM, SPEX 8000M) in a stainless steel vial and balls. After paraffin wax was added and milled for 30 min, iron oxalate was added and milled for 10 min. Finally, Li acetate was added and milled for 10 min.

The overall molar ratio was Li:Fe:P:oleic acid=1:1:1:1 with paraffin addition twice the weight of oleic acid. The precursor paste was dried in an oven at 110° C. for 30 min followed by heat-treatment in a tube furnace at 500° C. for 8 h under UHP-3% H₂/97% Ar gas flow with ramping rate of 5° C./min. After LiFePO₄ was synthesized, 10% carbon black by weight was added and milled in planetary mill for 4 h (Retsch 100 CM) at 400 rpm. X-ray diffraction (XRD) pattern (Philips Xpert) was obtained using CuKa (1.54 Å) radiation.

The microstructure of the LiFePO₄ was analyzed by a field-emission scanning electron microscope (FESEM, FEI Nova 600). The anatase TiO₂/graphene composite (2.5 wt. % graphene) was obtained by self-assembly approach described in D. Wang, D. Choi, J. Li, Z. Yang, Z. Nie, R. Kou, D. Hu, C. Wang, L. V. Saraf, J. Zhang, I. A. Aksay, J. Liu, ACS Nano 3 (4) (2009) 907.

13 mg of the functionalized graphene sheets (FGSs) and 0.6 mL of sodium dodecyl sulfate (SDS) aqueous solution (0.5 mol/L) were then mixed by sonication. 25 mL of TiCl3 (0.12 mol/L) aqueous solution was added into as-prepared SDS-FGS dispersions while stirring, followed by 5 mL of 0.6 M Na₂SO₄ and 2.5 mL of H₂O₂ (1 wt. %) dropwise addition. Deionized water was further added under stirring to make total volume of 80 mL which was further stirred in a sealed polypropylene flask at 90° C. for 16 h. The final precipitates were separated by centrifugation and washed with deionized water and ethanol three times. The product was then dried in a vacuum oven at 70° C. overnight and calcined in air at 400° C. for 2 h.

For electrochemical evaluations, the cathode and anode comprised of active material, Super P and poly(vinylidene fluoride) (PVDF) binder were dispersed in N-methylpyrrolidone (NMP) solution in a weight ratio of 80:10:10 for the anatase TiO₂/graphene anode and 90:3:7 for LiFePO₄/C cathode, respectively. Both cathode and anode slurries were then coated on an Al foil.

The performance of LiFePO₄ and anatase TiO₂/graphene electrodes were then evaluated, both in half and full 2325 coin cells (National Research Council, Canada) in 1 M LiPF6 in EC/DMC (2:1) (ethyl carbonate/dimethyl carbonate) electrolyte at room temperature, using an Arbin Battery Tester (Model BT-2000, Arbin Instruments, College Station, Tex., USA). The half-cells using Li as anode were tested between 4.3 and 2 V for LiFePO₄ and 3-1 V for anatase TiO₂/graphene at various C rate currents based on the theoretical capacity of 170 mAh/g for both cathode and anode whereas the full cell was tested in 1 Cₘ (measured C rate) rate. Due to the initial irreversible loss observed for anatase TiO₂/graphene anode, LiFePO₄ loading was 2.4 mg/cm2 and 1.1 mg/cm2 for anatase TiO₂/graphene in full cells and tested between 2.5 and 1 V where energy and power density was calculated based on the anode weight which is the limiting electrode.

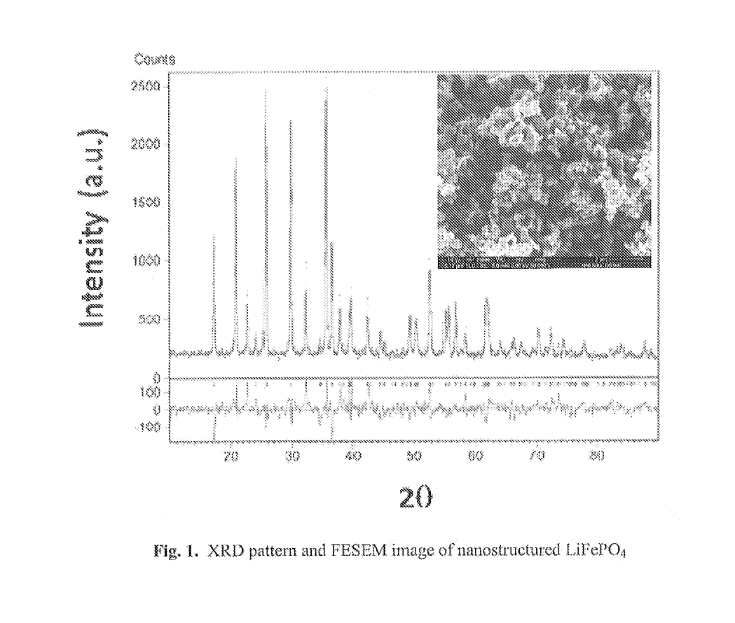

The LiFePO₄ synthesized using the molten surfactant approach, as shown in FIG. 1, produced well crystallized, nano-sized LiFePO₄ particles after heat treatment, unlike poorly defined crystallites produced using micelle or hydrothermal approaches. The X-ray diffraction analysis of LiFePO₄ shown in FIG. 1 shows lattice parameters of a=10.329 Å, b=6.005 Å, c=4.691 Å (Rp: 2.31, Rwp: 3.06, Rexp: 2.93) obtained via Rietveld refinement that matched closely to the ideally crystallized LiFePO₄ (JCPDS 81-1173, Pnma(62), a=10.33 Å, b=6.010 Å, c=4.692 Å). The crystallite size was determined to be ˜50 nm from the X-ray analysis; primary particle size ranges from 100 to 200 nm from FESEM observation. Anatase TiO₂/graphene composite show anatase TiO₂ nanoparticles (<20 nm) coated on graphene sheets as described in D. Wang, D. Choi, J. Li, Z. Yang, Z. Nie, R. Kou, D. Hu, C. Wang, L. V. Saraf, J. Zhang, I. A. Aksay, J. Liu, ACS Nano 3 (4) (2009) 907.

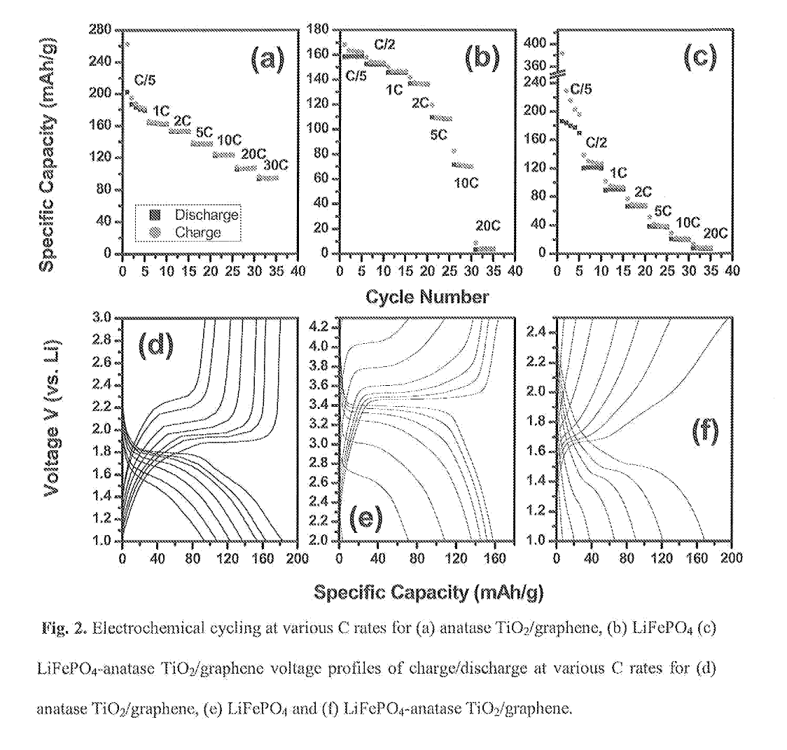

The synthesized anatase TiO₂/graphene, LiFePO₄ and full-cell configuration were then tested at various C rates as shown in FIG. 2(a-e). As shown in FIG. 2(a and d), the anatase TiO₂/graphene electrodes demonstrated flat voltage curves at 1.84 V, indicating a classical two-phase electrochemical reaction process of the Li insertion/extraction. Diffusion of Li-ions in the anatase TiO₂ framework is known to accompany symmetry transformations between I4₁/amd and orthorhombic Pmn2₁ when x=0.5 (LiₓTiO₂), resulting in a net increase of ˜4 vol. % of the unit cell leading to capacity fade. Hence, for bulk anatase TiO₂, x=0.5 is often considered as the maximum electrochemical insertion of Li. However, the reduction in particle size into the nanometer-regime (<100 nm) alternates the two-phase equilibrium phenomenon in the bulk to more of solid solution like Li uptake at the surface thus leading to increased capacity over 0.5 Li per unit formula.

As shown in FIG. 2(a), nano-sized anatase TiO₂/graphene composite gives more than 175 mAh/g (>0.5 Li) at C/5 rate and demonstrates good cycling capability. The anatase TiO₂/graphene also exhibited much higher rate response than that of LiFePO₄, reaching 90 mAh/g at 30 C (equivalent of measured 60 Cₘ rate). The LiFePO₄ electrode is characterized by a flat potential at around 3.45 V vs. Li from two-phase Li-extraction/insertion with specific capacity of 110 and 71 mAh/g at 5 C and 10 C (equivalent 8 Cₘ and 24 Cₘ rate), respectively.

The rate capacity of the full cell (FIG. 2(c)) is lower than both cathode and anode half-cells due to the lower electronic and ionic conductivity of both cathode and anode compared to Li metal used in half-cells. Based on capacity limiting electrode, anatase TiO₂/graphene, the LiFePO₄-anatase TiO₂/graphene full cell delivered ˜120 mAh/g at C/2 rate based on anode weight. The irreversible capacity loss during the first cycle was 23% for anatase TiO₂/graphene anode in half-cell and 52% in full cell. Nano-sized TiO₂ usually show 20-50% irreversible loss during the first cycle as described in G. Z. Yang, D. Choi, S. Kerisit, K. M. Rosso, D. Wang, J. Zhang, G. Graff, J. Liu, J. Power Sources 192 (2) (2009) 588. This is probably due to high surface area created by nano-sized TiO₂ and graphene which also shows Li-ion storage characteristic. In a full cell, electrode material balance leads to changes in voltage profile of each cathode and anode and can affect the degree of irreversible loss since initial operating voltage starts from 0.2 V (OCV) followed by continuous cycling between 1 and 2.5 V.

Enhancing rate performance is vital not only for achieving higher power but also for minimizing polarization from internal resistance where the latter lead to exothermic irreversible heat generation Qiᵢᵣᵣ=Iμt+I²Rt (I: current, μ absolute value of electrode polarization, R: Ohmic resistance, t: time) which plays critical role in heat management required for large scale systems. Such heat control can extend the cycle life of Li-ion battery.

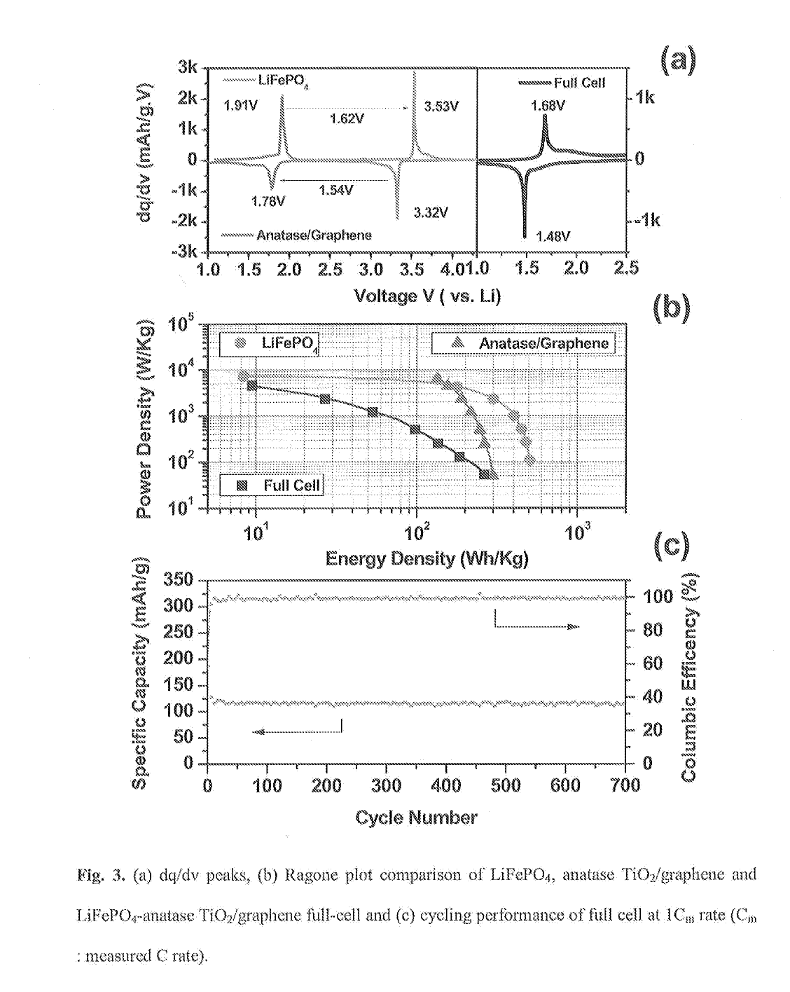

FIG. 3(a) shows dq/dv peaks of all electrodes tested at C/5 rate where full-cell potential of 1.6 V matches the voltage difference between cathode and anode peaks. Ragone plot of all three cells based on active material weight are compared in FIG. 3(b). The energy density of the full cell is limited by the anatase TiO₂/graphene due to the same specific capacity but lower voltage compared to LiFePO₄ whereas the power density is limited by the LiFePO₄ cathode.

The full-cell power density of 4.5 kW/kg and energy density of 263 Wh/kg based on capacity limiting anatase TiO₂/graphene anode weight lies within these two limitations with LiFePO₄ cathode limiting the rate, which is opposite to conventional Li-ion batteries using graphite anode.

The cycling performance of the full-cell battery at 1 Cₘ rate shown in FIG. 3(c) indicates almost no fade even after 700 cycles with columbic efficiency reaching 100% over the entire cycling test except for the initial few cycles where irreversible loss has been observed. The results confirm the ideal reversibility of the Li-ion batteries based on a combination of LiFePO₄-anatase TiO₂/graphene and the absence of losses due to parasitic processes, such as the electrolyte decomposition.

While the invention has been illustrated and described in detail in the drawings and foregoing description, the same is to be considered as illustrative and not restrictive in character. Only certain embodiments have been shown and described, and all changes, equivalents, and modifications that come within the spirit of the invention described herein are desired to be protected. Any experiments, experimental examples, or experimental results provided herein are intended to be illustrative of the present invention and should not be considered limiting or restrictive with regard to the invention scope. Further, any theory, mechanism of operation, proof, or finding stated herein is meant to further enhance understanding of the present invention and is not intended to limit the present invention in any way to such theory, mechanism of operation, proof, or finding. Thus, the specifics of this description and the attached drawings should not be interpreted to limit the scope of this invention to the specifics thereof. Rather, the scope of this invention should be evaluated with reference to the claims appended hereto. In reading the claims it is intended that when words such as “a”, “an”, “at least one”, and “at least a portion” are used there is no intention to limit the claims to only one item unless specifically stated to the contrary in the claims. Further, when the language “at least a portion” and/or “a portion” is used, the claims may include a portion and/or the entire items unless specifically stated to the contrary. Likewise, where the term “input” or “output” is used in connection with an electric device or fluid processing unit, it should be understood to comprehend singular or plural and one or more signal channels or fluid lines as appropriate in the context. Finally, all publications, patents, and patent applications cited in this specification are herein incorporated by reference to the extent not inconsistent with the present disclosure as if each were specifically and individually indicated to be incorporated by reference and set forth in its entirety herein.

The invention claimed is:

1. A cathode comprising nano-structured carbon in electrical communication with LiMPO₄, where M is a transition metal ion, said cathode having a specific capacity, wherein the cathode has sufficient structural stability to maintain at least 90 percent of the specific capacity of the cathode over 500 charge/discharge cycles.

2. The cathode of claim 1 wherein the cathode has sufficient structural stability to maintain at least 95 percent of the specific capacity of the cathode over 500 charge/discharge cycles.

3. The cathode of claim 1 wherein the cathode has sufficient structural stability to maintain at least 98 percent of the specific capacity of the cathode over 500 charge/discharge cycles.

4. The cathode of claim 1 wherein the cathode has sufficient structural stability to maintain at least 99 percent of the specific capacity of the cathode over 500 charge/discharge cycles.

5. The cathode of claim 1 wherein M in the LiMPO₄ is selected from the group consisting of Fe, Mn, Co, Ni and combinations thereof.

6. The cathode of claim 1 wherein M in the LiFePO₄ is Fe.

7. The cathode of claim 1 wherein the nano-structured carbon comprises graphene, carbon nano-tubes, and combinations thereof.

8. The cathode of claim 1 wherein the nano-structured carbon comprises graphene.

9. A lithium ion battery having an anode, an electrolyte, and a cathode comprising nano-structured carbon in electrical communication with LiMPO₄, where M is a transition metal ion, said cathode having a specific capacity, wherein the cathode has sufficient structural stability to maintain at least 90 percent of the specific capacity of the cathode over 500 charge/discharge cycles.

10. The lithium ion battery of claim 9 wherein the cathode has sufficient structural stability to maintain at least 95 percent of the specific capacity of the cathode over 500 charge/discharge cycles.

11. The lithium ion battery of claim 9 wherein the cathode has sufficient structural stability to maintain at least 98 percent of the specific capacity of the cathode over 500 charge/discharge cycles.

12. The lithium ion battery of claim 9 wherein the cathode has sufficient structural stability to maintain at least 99 percent of the specific capacity of the cathode over 500 charge/discharge cycles.

13. The lithium ion battery of claim 9 wherein M in the LiMPO₄ is selected from the group consisting of Fe, Mn, Co, Ni and combinations thereof.

14. The lithium ion battery of claim 9 wherein M in the LiFePO₄ is Fe.

15. The lithium ion battery of claim 9 wherein the nano-structured carbon comprises graphene, carbon nano-tubes, and combinations thereof.

16. The lithium ion battery of claim 9 wherein the nano-structured carbon comprises graphene.

17. A cathode comprising graphene in electrical communication with LiMPO₄, where M is a transition metal ion, said cathode having a specific capacity, wherein the cathode has sufficient structural stability to maintain at least 90 percent of the specific capacity of the cathode over 500 charge/discharge cycles.

18. The cathode of claim 17 wherein the cathode has sufficient structural stability to maintain at least 95 percent of the specific capacity of the cathode over 500 charge/discharge cycles.

19. The cathode of claim 17 wherein the cathode has sufficient structural stability to maintain at least 98 percent of the specific capacity of the cathode over 500 charge/discharge cycles.

20. The cathode of claim 17 wherein the cathode has sufficient structural stability to maintain at least 99 percent of the specific capacity of the cathode over 500 charge/discharge cycles.

21. A lithium ion battery having an anode, an electrolyte, and a cathode, said cathode comprising graphene in electrical communication with LiMPO₄, where M is a transition metal ion, said cathode having a specific capacity, wherein the cathode has sufficient structural stability to maintain at least 90 percent of the specific capacity of the cathode over 500 charge/discharge cycles.

22. The lithium ion battery of claim 21 wherein the cathode has sufficient structural stability to maintain at least 95 percent of the specific capacity of the cathode over 500 charge/discharge cycles.

23. The lithium ion battery of claim 21 wherein the cathode has sufficient structural stability to maintain at least 98 percent of the specific capacity of the cathode over 500 charge/discharge cycles.

24. The lithium ion battery of claim 21 wherein the cathode has sufficient structural stability to maintain at least 99 percent of the specific capacity of the cathode over 500 charge/discharge cycles.
